(19) United States
(12) Patent Application Publication
(10) Pub. No.: US 2024/0338679 A1
(43) Pub. Date: Oct. 10, 2024

(54) System and method for using tokens to track and distribute assets

(71) Applicant: Ashish Kumar, Lewisville, TX (US)

(72) Inventor: Ashish Kumar, LEWISVILLE, TX (US)

(73) Assignee: Ashish Kumar, Lewisville, TX (US)

(21) Appl. No.: 18/626,026

(22) Filed: Apr. 3, 2024

Related U.S. Application Data
(60) Provisional application No. 63/456,807, filed on Apr. 4, 2023.

(51) Int. Cl. G06Q 20/36; H04L 9/00

(52) U.S. Cl. CPC G06Q 20/367; H04L 9/50

(57) ABSTRACT

A method and system for creating and managing secure tokens associated with users and assets. The method and system of the present invention provide mechanism for dynamically associating a token with one or more users as owners and one or more assets to track the changes in value of those assets. The monetary value of token is determined using a functional relationship with associated assets. The token can be monetized by users associated with the token as owners in the proportion of their ownership. Monetization of the token represents processing of payments equivalent to the monetary value of the token at the time of monetization.

### CROSS-REFERENCE TO RELATED APPLICATIONS

This application claims the benefit of U.S. Provisional Application No. 63/456,807, filed on Apr. 4, 2023.

### BACKGROUND OF THE INVENTION

### Field of the Art

The method and system of the present invention relate to the field of communication between devices for information and data management using a network. More particularly, but not exclusively, the method and system of the present invention relate to the field of data tokenization for asset correlation for the purpose of mapping, tracking and monetization based on the underlying asset value.

### Discussion of the State of the Art

There has been a significant rise in tokens created for holding some value themselves such as Bitcoin, Ethereum and other cryptocurrencies. On the other hand, some physical assets themselves are first digitized and then tokenized such as Non-fungible Tokens (NFTs) which are traded for some value derived from the asset contained within the token. An NFT can be thought of as an irrevocable digital certificate of ownership and authenticity for a given asset, whether digital or physical. But in all cases the token itself represents a whole asset such as a digital coin, a digital art piece or a stock and is also owned by one user. One problem with such tokens is that they are tied to only one given asset and only one user. Another problem with such tokens is that if the token holder wants to convert the underlying asset then the token itself changes. For example, a holder of Bitcoin token can convert it into an Ethereum token at multiple crypto exchanges that exist today by first selling the Bitcoin and then buying the Ethereum for the same monetary value. The holder will then receive an Ethereum token after surrendering her Bitcoin token to the exchange. This process is cumbersome and not very energy efficient either.

The applicant is unaware of the existence of any such electronic token and electronic communication based secure token management system that contains the above features and addresses the above described shortcomings in the prior art. More specifically, there is no such computer-based system and method known in the prior art that allows the creation of tokens representing a value derived from a correlation of value of one or more underlying assets chosen with the consensus among the users associated with the token. Furthermore, such system does not exist that allows a user to use an existing computer readable code, provide it a desired initial monetary value and then associate that code with a cryptographically secure token to represent a specified set of assets and track the value of those assets using the cryptographically secure token or the original computer readable code itself.

No such system exists where the same token can be modified to represent a new set of underlying assets and correlation function for a given value of the token at the time of such conversion allowing for computation of the value of the token using the spot value of the new underlying assets and the correlation function that contains the appropriate weight for each of the new underlying asset. Furthermore, no such system exists that allows the holder of such token to monetize the token value into a regular currency, a digital currency, gift card or another form of money used for regular payments. Currently there exists no such system or method that allows the creation of a digital cryptographically secure token based on an initial cash amount paid by a user; optionally associating the secure token with another physical and visible computer readable code; then selecting the assets that should be included in the token, then generating a correlation function to map the selected asset values with equivalent value of the cash amount at the time of token creation; and then being able to redeem that token at a later time for the value determined by the asset values included in the correlation function at the time of redemption less any transaction costs or fees. Also there exists no token management system that can transfer the ownership of token from one user to another user without creating a new token.

However, a token can be created as a mere representation of the asset wherein the token specifies a correlation with underlying asset or assets without the need of actually digitizing the assets themselves. That means that tokenization or digitization of the asset itself is not required for a token to represent a value associated with an underlying asset as long as the token clearly specifies the relationship with the underlying asset in the form of a correlation function with the asset value as a variable and a smart contract that provides a guarantee from the token creator to the token owner to receive an equivalent value of the token as determined by the correlation function of the underlying assets. Similarly, a token can contain information about multiple users, their role and ownership interest of those users that have a “token owner” role associated with the token.

One benefit of such a method and system is that the same token can be easily converted to hold a correlation to a different underlying asset than the one originally used at the time of token creation by simply modifying the correlation function to remove the correlation with old assets and include the correlation with new assets. Still another benefit of such method and system is that a token can be created to hold compound assets in the form of a correlation function with more than one variable where each variable represents a different asset. So, a single token can represent one Bitcoin plus one Ethereum or one Bitcoin and one share of S&P500 exchange traded fund (ETF) et cetera.

One more benefit of such method and system is that these tokens can be easily gifted or given by one person to another person by only modifying the ownership information elements of the token. Also, the person giving the gift can get the token with first underlying asset and the person receiving the gift can easily convert it into a second underlying asset of her choice without any complexity of creating a new token with a new token identifier. The value of the token is simply determined by the spot value of all the assets included in the correlation function and the correlation function itself. Furthermore, if the token is associated with a machine-readable code such as a quick-response (QR) code or a barcode then users can easily access the token details by simply scanning the code using a device with a camera.

Another benefit of such method and system is that multiple tokens can be created to track the same asset. Asset itself can be a physical asset or virtual asset as long as the provider of the token and holder of the token guarantee that the value of the token is determined by the underlying correlation function and agreed upon in a smart contract contained within the token. Still another benefit of such method and system is that the tax calculations associated with the token value changes can be handled optimally by the token creator centrally and optionally avoids each token holder from the tax implications. Such tokens also reduce the energy requirements associated with new token creation typically needed in token management systems of the prior art.

### SUMMARY OF THE INVENTION

Accordingly, the inventor has conceived and reduced to practice a computer-based method and system for creating a digital token based on an initial monetary value provided by a token buyer, then selecting a plurality of assets that should be included in the token, then generating a correlation function to map the initial monetary value to a combined value of the selected assets at the time of token creation and then being able to redeem that token at a later time for the value determined by the asset values included in the correlation function at the time of redemption less any deductions such as but not limited to transaction costs, taxes or fees.

The present invention introduces novel method, system, device, and data processing application having a program and circuitry for initiating and completing the creation of a secure digital cryptographic token comprising a correlation function with a plurality of underlying real assets such as the combined value of the current spot value of the associated assets represents a current monetary value of the token. The token can be dynamically associated with multiple users as owners and multiple assets as underlying assets. The correlation function further specifies a plurality of factors for tracking changes in the monetary value of the token based on the changes in the value of the underlying assets. The underlying real asset can be any asset that is regarded as holding some value and it may include but is not limited to physical assets such as a stock, exchange traded funds (ETFs), gold, real estate or a painting; digital assets such as Bitcoin or digital media; or a virtual assets such as another token. The factors in the correlation function represent the weight of the value of the corresponding asset in the overall value of the token and may be represented as whole or fractional numbers or in any other complex algebraic relationship. The system includes a central computer executing a data application connected to a network for communication with other devices. Another embodiment of the present invention provides a method, system, device, and data platform for receiving a request for creating a token from a client device wherein the client device provides an initial monetary value for the token. Additionally, the client device may also specify the assets that it wants the token to track. The system creates a token and then uses the method to generate a correlation function with appropriate factors for each specified asset equivalent to the current monetary value for the token. One objective the present invention is to allow tokens to be created by the system and associate them with a unique physical machine-readable code such as but not limited to a barcode, QR code etc. A client device comprising a barcode scanner can scan the code and then communicate with the system to provide an initial monetary value for the token associated with that code. Client device can further communicate with the system over the network and specify the assets that it wants to correlate with the token. In one embodiment of the present invention the system may pre-determine an asset to correlate with the token. In still another embodiment of the present invention, the system may communicate with a plurality of external applications for asset information management such as but not limited to receiving the information about the current spot prices of the asset, verifying the asset, placing an order to buy or sell the asset, or creating position hedges for the asset associated with the token.

Another objective of the present invention is to provide a method and system to transfer ownership of the token from one user to another user. The token can be associated with one user or multiple users as the owners of the token. The system and method also allow addition, deletion and modification of certain attributes of the token such as but not limited to future transfer of the ownership, locking any ownership changes, minimum holding period etc. Still another objective of the present invention is to allow token owner to change the underlying assets to a different set of assets by updating the correlation function. Another objective of the present invention is to allow the creation of digital token that can track the performance of underlying assets in the weight proportion of each asset as determined by the correlation function of the digital token. Still another objective of the present invention is to provide the mechanism to verify the validity of the token itself using a central controller. Another objective of the present invention is to provide the mechanism to redeem the digital token into regular cash, a digital currency, a gift card or any other such monetary equivalent for the purpose of monetary transactions with third parties.

Still another objective of the present invention is to provide a method and system to interface with external third-party payment systems to make the payments using the monetary value of the token and further updating the parameters of the correlation function comprising asset factors to represent the updated monetary value of the token. Still another objective of the present invention is to establish the validity, authenticity and non-repudiability of the token and the information contained within the token.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary, and are not to be considered as limiting of the scope of the invention or the claims herein in any way.

FIG. 1 shows the preferred embodiment of the overall system architecture.

FIG. 2 is a block diagram showing one embodiment of central controller.

FIG. 3 is a block diagram showing one embodiment of the device entity involved in the electronic token transaction.

FIG. 4 illustrates exemplary data structure of a cryptographic token used to map and track underlying assets in one embodiment.

FIG. 5 shows the flow diagram of one embodiment of the central controller receiving a request to create a token for tracking certain assets and steps for processing the request.

FIG. 6 illustrates a flow diagram of another embodiment wherein central controller has pre-created machine-readable codes that a client device can use to request token creation for mapping and tracking of selected assets.

FIG. 7 illustrates a flow diagram for associating user information to a cryptographic token used for asset tracking.

FIG. 8 show the flow diagram of one embodiment of the central controller receiving and processing a request from a client device to redeem a token.

FIG. 9 shows the flow diagram of further processing done by the central controller if token is redeemed by converting it into other payment methods using a payment gateway.

FIG. 10 describes the flow chart of an embodiment for processing a request to change the underlying assets that are tracked by the cryptographic token after the initial creation of the token.

FIG. 11 describes the flow chart of one embodiment for processing a request to change the ownership of the cryptographic token after the initial creation of the token.

FIG. 12 illustrates a flow diagram for one embodiment where central controller determines tax and fees associated with a cryptographic token.

FIG. 13 shows the flow diagram for interaction between central controller and a client device for validating an information message and updating the cryptographic token based on the request comprised within the information message.

FIG. 14 illustrates a flow diagram for one embodiment of the interaction between central controller and a client device wherein assets to track using the token are pre-selected by the central controller.

The figures are described in greater detail in the next section of the patent.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Similarly, although process steps, method steps, algorithms or the like may be described in a sequential order, such processes, methods and algorithms may generally be configured to work in alternate orders, unless specifically stated to the contrary. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

### Definitions

As used herein the following terms have the meaning given below:

“Cryptographic token”—means a data structure in digital format comprising information elements wherein data transformation has been applied for the security, authenticity and non-repudiability of the information.

“Token”—means “Cryptographic token” as described above and has been used interchangeably with “Cryptographic token” in the description and drawings.

“User”—means any entity that wants to buy and/or use the cryptographic token and submits the request for token processing to the central controller. This entity may register itself with the central controller. Upon registration, central controller will verify the entity and assign an identification code to the entity. This entity may also use the tokens for accepting payments for peer-to-peer transactions.

“Business User”—means any entity that wants to buy, sell and/or use the cryptographic token and submits the request for token processing to the central controller. This entity may register itself with the central controller. Upon registration, central controller will verify the entity and assign an identification code to the entity. This entity may also use the tokens for accepting payments for business transactions.

“Client device”—means any computer device for a user to interface to at least one controller. This may be, but not limited to, user terminals comprising a computer and browser can be any such device as a typical computer, WebTV et cetera that can connect to a network, a portable device be any of the various types of devices such as laptops, smartphones, PDAs, barcode scanner or any other device capable of communicating over a network.

“Business client device”—means any computer device for a buyer to interface to at least one controller. This may be, but not limited to, user terminals comprising a computer and browser can be any such device as a typical computer, WebTV et cetera that can connect to a network, a portable device be any of the various types of devices such as laptops, smartphones, PDAs, payment terminals or any other device capable of communicating over a network.

“Assets”—means a physical or virtual asset that has an ability to represent and hold some monetary value wherein the monetary value itself may change over time.

“Central controller” or “Controller”—means, in a preferred embodiment, an entity comprising a network-connected controller computer comprising at least a processor and a storage device further comprising a program stored in the storage device and operating on the processor, the program adapted to implement a system and method for managing interaction between a plurality of client devices for the purpose of creating and managing token to map and track the value of a plurality of assets. This entity, in a preferred embodiment, may have manual and/or automated operation using a computer system and/or web server. Such an entity may also be a single entity or a distributed entity as deemed fit by a particular embodiment.

### DETAILED DESCRIPTION OF EXEMPLARY EMBODIMENTS

This invention may involve novel methods, system, message formats, and data structures for a buyer-initiated bid offer request and response management system. The following description is presented to enable one skilled in the art to make and use the invention, and is provided in the context of particular applications and their requirements. Various modifications to the disclosed embodiment will be apparent to those skilled in the art, and the general principals set forth below may be applied to other embodiments and applications. Thus, the present invention is not intended to be limited to the embodiments shown and the inventor regards this invention as any patentable subject matter described herein.

A preferred embodiment of the invention consists of a central controller that connects the buyer devices to the seller devices. In the preferred embodiment of this invention buyers and seller devices communicate with the central controller using an electronic network.

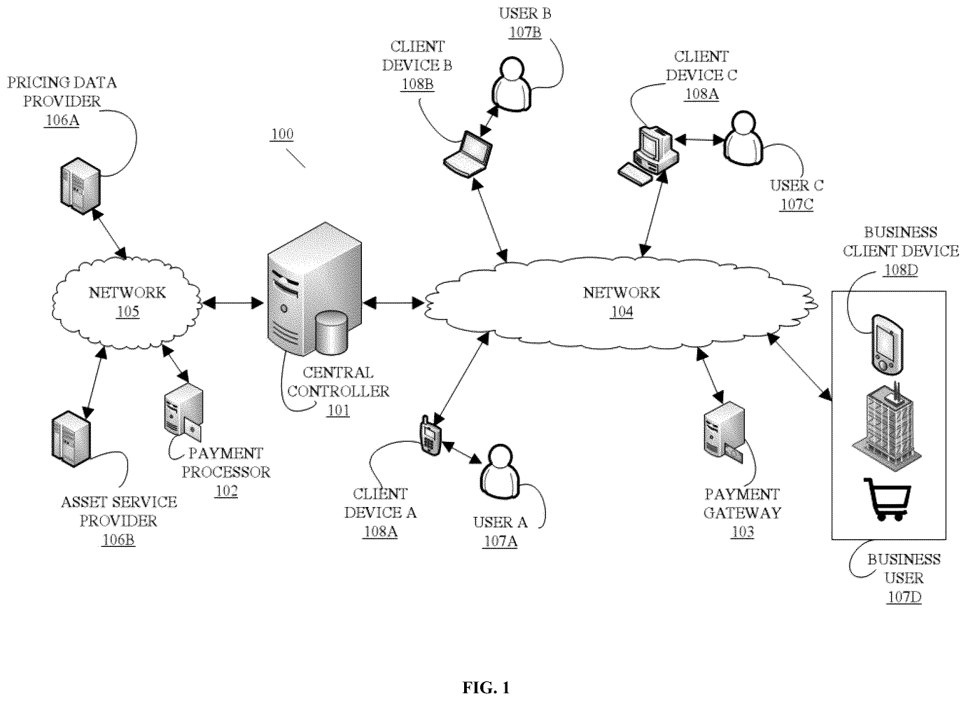

An overall diagram of one exemplary embodiment 100 of the invention is shown in FIG. 1. In general, the system architecture connects client devices 108A to 108D, collectively referred to as client devices 108, and central controller 101 via a network 104. Users 107 are designated 107A to 107D and are collectively referred to as users 107. There can be users 107 and client devices 108; however, the actual number of users 107 and client device 108 used by the user is not relevant so long as there is at least one user 107A connected using the client device 108A. Client devices 108 may use different online and offline communication interfaces to communicate with central controller 101. Typically, but not necessarily, communication is handled via a network, for example, the Internet. Client device 108A may be any such device as a typical computer, smartphone, tablet, WebTV, et cetera, that can connect a network, for example, the Internet, Global System for Mobile Communication (GSM) network et cetera.

Central controller 101 may also be connected to the internet via an ISP. Client device 108A and 108B can be using a dedicated client application running on the electronic client devices using iOS™, Android™, Windows™ or any other such operating system. Another type of client device 108C and user 107C can communicate directly with central controller 101 using a web portal running in a browser such as Chrome® or Safari®. Still another client devices 108D can be installed on the premises on a business user 107D and use a facsimile machine or any such device that is able to communicate electronically, for example, wireless mobile networks, PSTN (Public switched telephone network), ISDN (Integrated services digital network), satellite or other like electronic communication channels. Devices 108 may also have ability to scan an image using a camera or a barcode scanner.

Client devices and/or central controller can communicate by sending and receiving a byte stream over the electronic communication channel using, for example, Transmission Control Protocol (TCP) and/or User Datagram Protocol (UDP) over Internet Protocol (IP), etc. Such electronic communication channel may consist of a wired connection, for example, using a telephone line, Digital Subscriber Line (DSL), Wireless (using 802.1la/b/g or WiMAX etc.), cellular (Code Division Multiple Access ‘CDMA’ or General Packet Radio Service ‘GPRS etc.), or any other like communication channel.

Although not shown in FIG. 1, user and device entities can also communicate with central controller using, for example, SMS (Short Message Service), MMS (Multimedia Message Service), postal mail, electronic mail, facsimile and/or other such offline communication channels. The lines in FIG. 1 therefore represent logical information flow and not the physical connections.

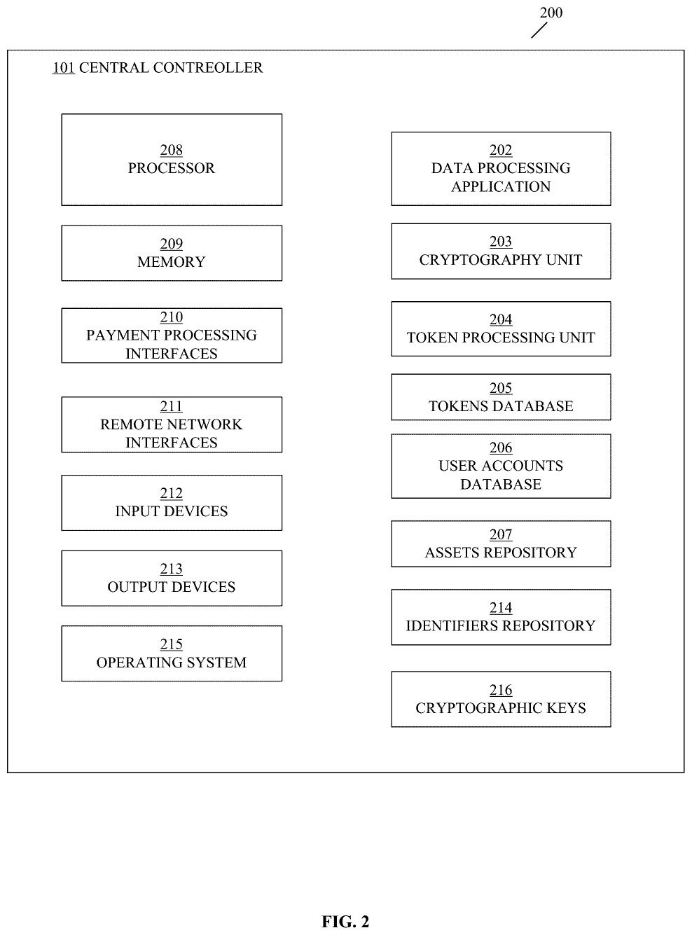

A typical central controller 101, as shown in FIG. 2 with schematic 200, can be a high-speed computer comprising a processor or central processing unit (“CPU”) 208, memory unit 209, data processing application 202, input devices 212, output devices 213, operating system 215, and database systems. CPU 208 may be a 3.2 GHz Intel Core i7™ microprocessor, for example. Application server 202 can be a Java™ Application Server using Java™ Platform, Enterprise Edition or .NET™ Server developed by Microsoft™. Application server runs a customized software application for processing and handling of token requests, responses and transaction messages in the present invention using a software-based message exchanged via network interface 211 and payment processing interface 210.

Cryptography unit 203 contains programmable code providing methods for generating and managing cryptographic keys such as Secure Socket Layer (SSL) keypair, computing hash values, data encryption and interaction with blockchains among other things. Token processing unit 204 contains programmable code providing methods for computing asset weights, generating and updating correlation function and other token related function. Data processing application 202, cryptography unit 203, token processing unit 204 and other programmable code contained within the memory 209 and executed by the processor 208 may use Database Management System (DBMS) manufactured by, for example, Teradata™ or Oracle Corp™. to access the tokens database storage 205 containing tokens data, accounts database store 206 comprising user accounts data, asset repository 207 comprising data about various assets and identifiers repository 214 comprising machine-readable codes data. Data storage devices 205 to 207 and 214 may contain databases used in the processing of token processing requests, responses and transaction messages of various embodiments of the present invention.

Accounts database 206 may contain data attributes for user accounts such as user's location, address, payment information, unique user identifier, email addresses of the user, phone number, purchased tokens and other user account related information.

Assets repository 207 may contain data attributes for assets such as asset description, asset details, periodic values of the asset, asset identifier and other asset related records and information. In some instances, repository 207 may contain the digital assets, a digital representation of the physical asset, a digitally signed and secured contract associated with the asset ownership or a digital record of the open positions and hedges related to the asset.

Identifiers repository 214 may contain information about the keyword subscription, QR code, barcode, user's email address, user's phone numbers or any other identifiers associated with cryptographic tokens.

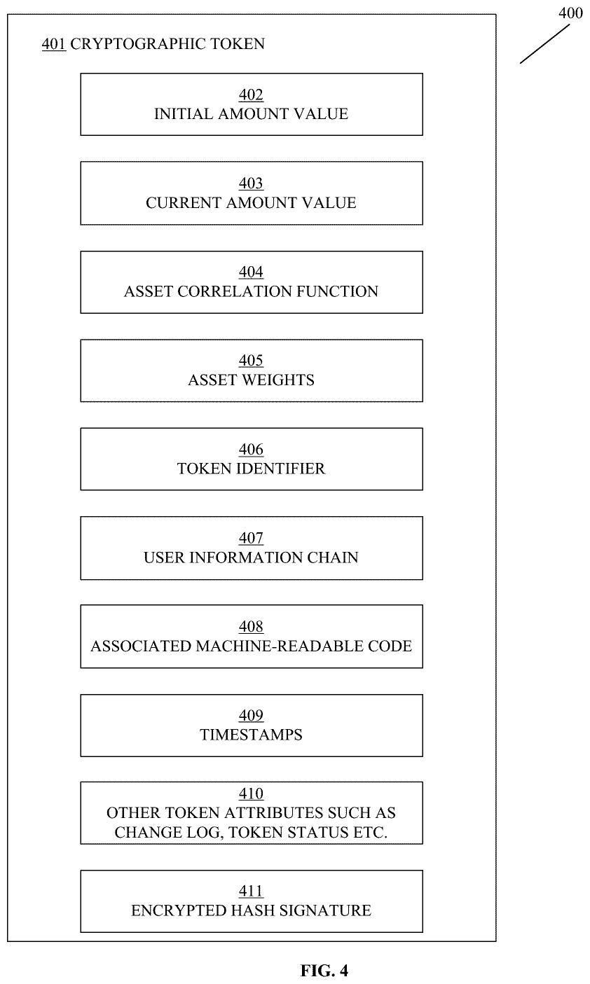

Tokens database 205 may contain attributes for all system generated secure cryptographic token codes such as associated assets weighted average function, asset values and token value correlation function, user identifier, token identifier, token description, validity period, detailed final token agreement signed using the system generated keys, a computed hash value of token data, encrypted token data using central controller's private key, etc. FIG. 4 shows attributes of a secure cryptographic token as stored in the tokens database.

Cryptographic keys 216 are used by the cryptography unit 203 for identifying users, for encrypting and decrypting information messages, for authentication, securing and non-repudiation information elements contained within databases et cetera. An example of such keys is secure socket layer (SSL) public-private key pair for an entity wherein the entity can use the private key to encrypt the data that can only be decrypted using the corresponding public-key and vice versa.

While some embodiments may describe the central controller 101 as a single computer, those skilled in the art will realize that the functionality can be distributed over a plurality of controller computers. As such some application server software components may reside within user client devices 108A, 108B, 108C, 108D et cetera.

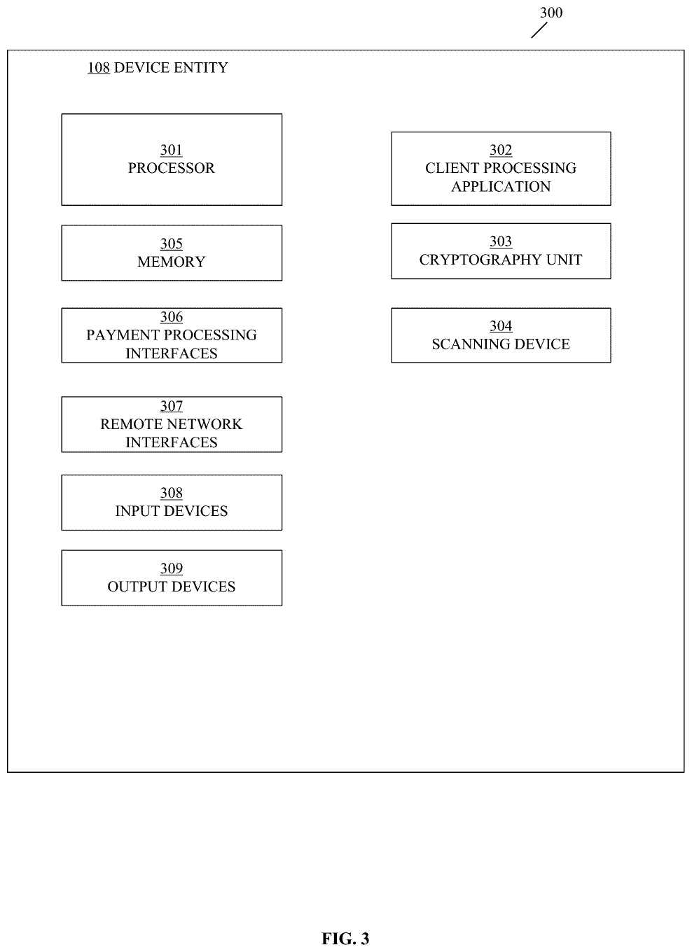

FIG. 3 shows one embodiment of the schematic 300 of a client device entity 108 comprising a processor 301 which may be an ARM® processor; memory module 305; input devices 308 which may include a keypad, a camera, a Bluetooth® interface et cetera; output devices 309 such as a screen, a speaker et cetera.; an interface 306 to make payments which may include an application, a card reader, a cash counter et cetera; an interface 307 for network connection which allows the device to connect to other devices over a network such as Internet; a device 304 for scanning images which may be a camera or an externally connected machine-readable code scanner via an USB or Bluetooth® interface; a cryptographic unit 303 that can execute the code to verify digital signatures, compute hash values and encrypt/decrypt data; and a client application 302 that contains code for processing request-response communication between the central controller 101 and the client device 108.

FIG. 4 shows by the way of a non-limiting example the schematic data structure 400 of the cryptographic token 401 as generated by central controller 101. Cryptographic token contains multiple attribute fields which are populated by the central controller 101. Field 406 is the unique token identifier that may be used by central controller 101 as a necessary and sufficient condition to identify a token contained in the cryptographic tokens database as a valid token at any point in time. Field 402 represents the initial amount in a default currency used by the system that represents the value of the token at the time of token creation within the system. Field 403 represents the current amount value of the token in the default currency. This value may be different from initial value 402 as the token may be partially or fully redeemed or the value of underlying assets may have changed or the underlying assets may have changed since the time token was created. Field 404 is the asset correlation function that allows computation of token value based on the value of underlying assets. Asset weights are stored in field 405 and are calculated by the token processing unit 204 of the central controller 101. Field 407 stores the user information attributes of all the users representing the ownership of the token and transfer of ownership from one user to another user. The token may also be associated with a unique machine-readable code such as a Quick Response (QR) code or a barcode as represented by the field 408. Field 409 stores all the timestamp in a linked-list for token lifecycle events such as token creation time, token update time et cetera. Field 410 represents additional data attributes of a token such as an expiration date for the token as determined by central controller 101, status of the token, changelog for the token, a smart contract describing token details, asset details et cetera. Field 411 contains a hash value of token information elements that may be encrypted using a secret private key from a set of private keys belonging to the central controller 101 and another iteration of encryption can be applied using the private key belonging to the user marked as the current owner of the token. A cryptographic tracking token may also contain a subset of these fields or additional fields as may be determined appropriate within a particular embodiment.

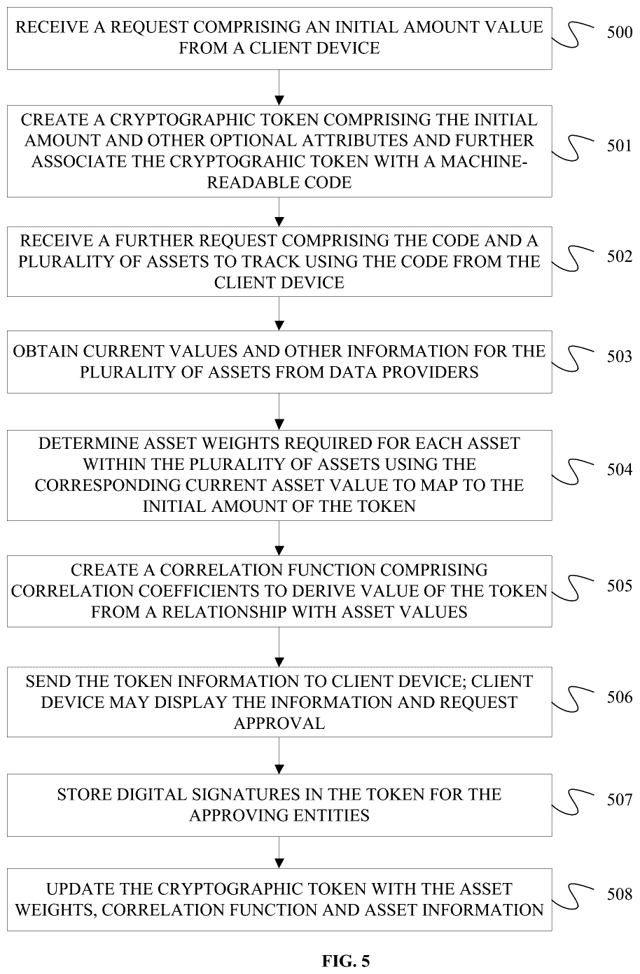

FIG. 5 with continued reference to FIG. 1 and FIG. 2 shows the sequence of steps taken and processing of messages among user, central controller and client device in one embodiment. User 107 determines an initial amount and inputs it into a client device 108 running the client application. Central controller 101 receives a request from the client device 108 via client application in step 500 wherein the request comprises an initial amount for which a tracking token should be created. Central controller creates a token in step 501 by generating the data associated with the token such as the initial amount, a QR code, timestamp, client device information. Central controller then computes the hash value of the token using a Secure Hash Algorithm (SHA-256) and encrypts the hash value using one private key corresponding to the central controller. Central controller then includes the secured hash value and the public key corresponding to the private key used for encryption in the token data and stores it in the tokens database 105. Central controller sends the QR code associated with the token to the client device in the response message. After receiving the code, the client device sends another message to the central controller comprising a list of requested assets that the user wants to include in the token for tracking purpose. Upon receiving the message in step 502, central controller identifies the requested assets and determines if the assets are eligible for tracking using the cryptographic token created in the step 501. Central controller in step 503 connects to data providers to obtain the information such as current price, asset availability, asset description et cetera about each asset in the list of requested assets.

In step 504 of FIG. 5, central controller determines a function that uses the current value of requested assets, availability et cetera to create weights for each selected asset so that the weighted average of asset value is equivalent to the initial amount value of the token less any transaction costs or fees. Further in step 506, the central controller creates a correlation function with correlation coefficients for each asset that establish the relationship between the total value of the token and the value of each asset in the list of assets at any given time. Central controller may send asset weights, correlation coefficients and other token information elements to the client device that can display the information about token composition to the user in step 507. Depending on the token attributes, central controller and client device may use digital signatures to sign token elements and secure the token information in step 508. Central controller 101 updates and stores the updated token in the tokens database 205.

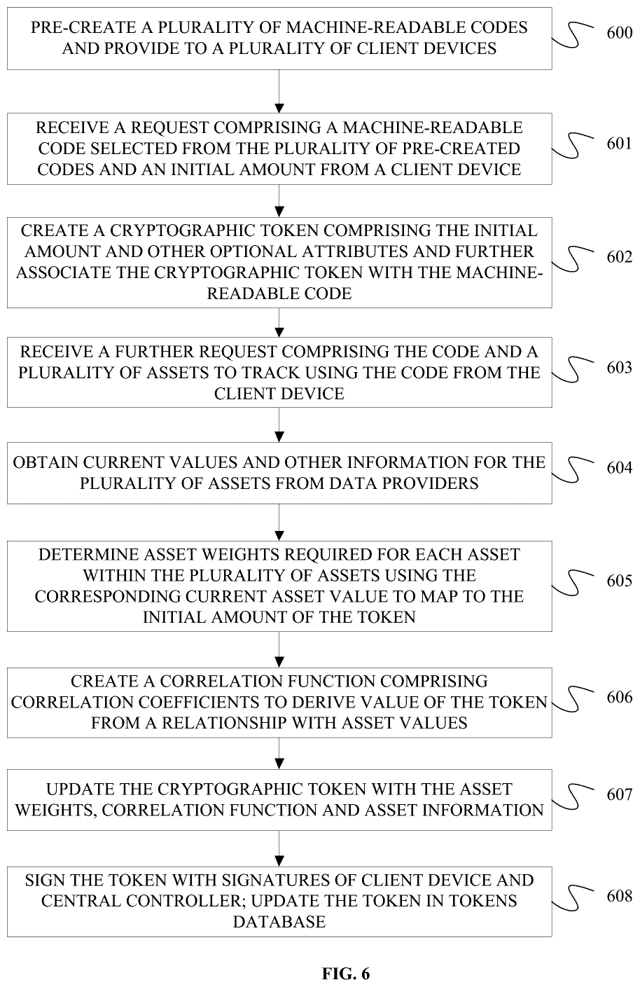

In another embodiment of the present invention as shown in step 600 of FIG. 6 with continued reference to FIG. 1, central controller 101 may store a plurality of pre-created machine-readable codes and machine-readable codes may be distributed to plurality of client devices such as business client device 108D associated with business user 107D. Another user 107A may select a machine-readable code provided by the business client device 108D to user's client device 108A. In step 601, user client device 108A sends the selected machine-readable code and an initial amount to the central controller 101. Central controller creates a token in step 602 by generating the data associated with the token such as the initial amount, a QR code, timestamp, client device information. Central controller then computes the hash value of the token using a Secure Hash Algorithm (SHA-256) and encrypts the hash value using one private key corresponding to the central controller. Central controller then includes the secured hash value and the public key corresponding to the private key used for encryption in the token data and stores it in the tokens database 205. The client device sends another message to the central controller comprising a list of requested assets that the user wants to include in the token for tracking purpose. Upon receiving the message in step 603, central controller identifies the requested assets and determines if the assets are eligible for tracking using the cryptographic token created in the step 602. Central controller in step 604 connects to data providers to obtain the information such as current price, asset availability, asset description et cetera about each asset in the list of requested assets. In step 605, central controller determines a function that uses the current value of requested assets, availability et cetera to create weights for each selected asset so that the weighted average of asset value is equivalent to the initial amount value of the token less any transaction costs or fees. Further in step 607, the central controller creates a correlation function with correlation coefficients for each asset that establish the relationship between the total value of the token and the value of each asset in the list of assets at any given time. Central controller computes the hash value and encrypts the token using digital signature of the client and the central controller and updates the token in tokens database 205 as shown in step 608. Authenticity and non-repudiability of the token is achieved by using the secret key associated with the user and the central controller. Token can be verified using the corresponding public or shared keys associated with the secret key.

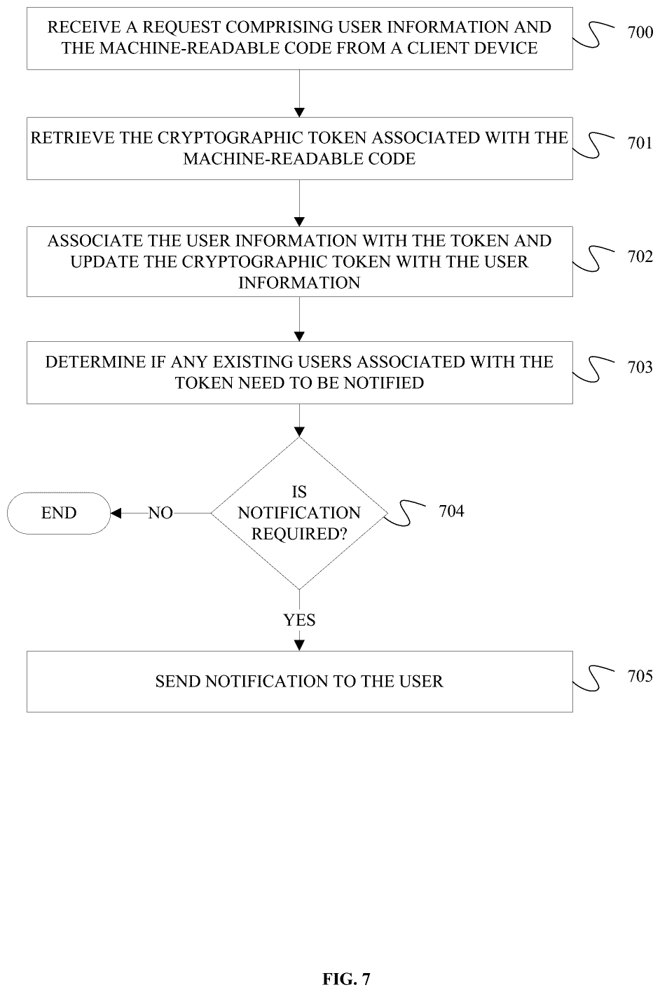

In the preferred embodiment of the present invention, the user may want to associate user's information with the token as shown in the flow diagram of FIG. 7 with reference to FIG. 1. The user 107A may input her information in client device 108A and central controller 101 receives the information from client device in step 700. In step 701, central controller retrieves the token associated with the machine-readable code included in the request message received from the client device. In step 702, central controller then associates user information with the token and updates the token in tokens database. Central controller may also determine in step 703 if any existing users identified from the plurality of users' information already associated with the token need to be notified about the token update. If notification is required for any user in the plurality of users then central controller sends the notification in step 705.

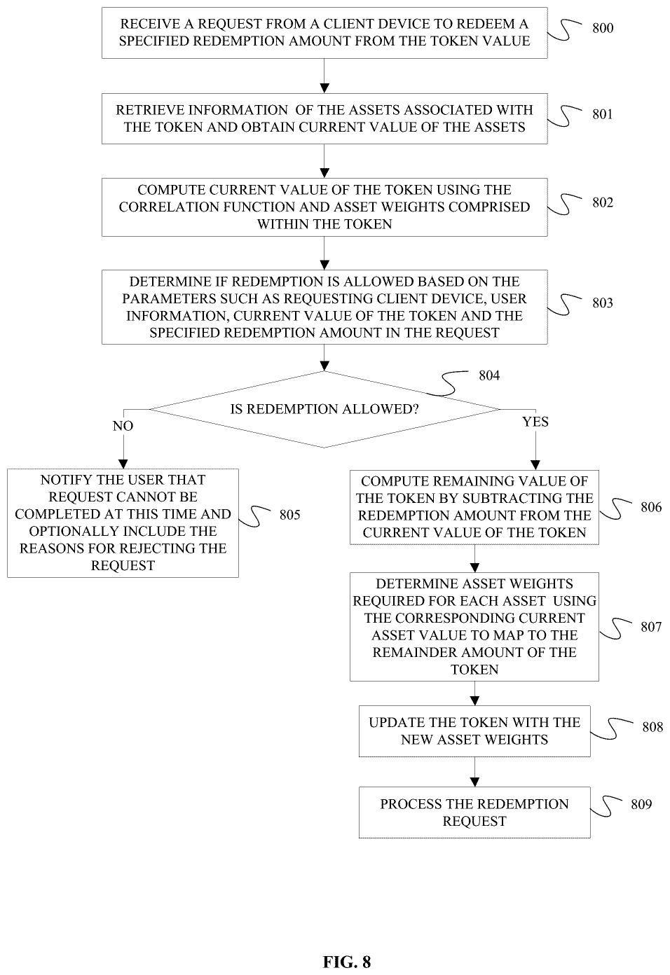

The preferred embodiment of the present invention provides method for partial or full redemption of the cryptographic token at any time as shown in the flow diagram of FIG. 8. In step 800, central controller receives a request from the client device to redeem a specific amount from the token value. The request may comprise a QR code, token identifier, the user's information and the redemption amount. Central controller, in Step 801, retrieves the token using request parameters and fetches the information about current value of the assets associated with the token. In step 802, token processing unit 204 of the central controller 101 computes the current value of the token using the correlation function comprised within the token information and current asset values. Central controller further determines in Step 803 if token redemption is allowed based on other token attributes such as current ownership, redemption lock status, current token value, requested redemption amount et cetera. A redemption lock status flag may be set for example due to a minimum holding period for the token, if token was given as a gift for person to hold for a minimum period et cetera. If redemption is not allowed then, in step 805, a notification response message is sent to the requesting client device. If redemption is allowed then request processing continues in step 806 by computing the remainder value of the token after subtracting the requested redemption amount from the current value of the token. In step 807, central controller updates the weights for each selected asset so that the weighted average of current asset value is equivalent to the remainder amount value of the token less any transaction costs or fees. Token information is updated in the tokens database 205 in step 808. In step 809, central controller processes the redemption request by sending the payment information including redemption amount, account information related to redemption request to the payment processor 102 via the payment processing interface 210.

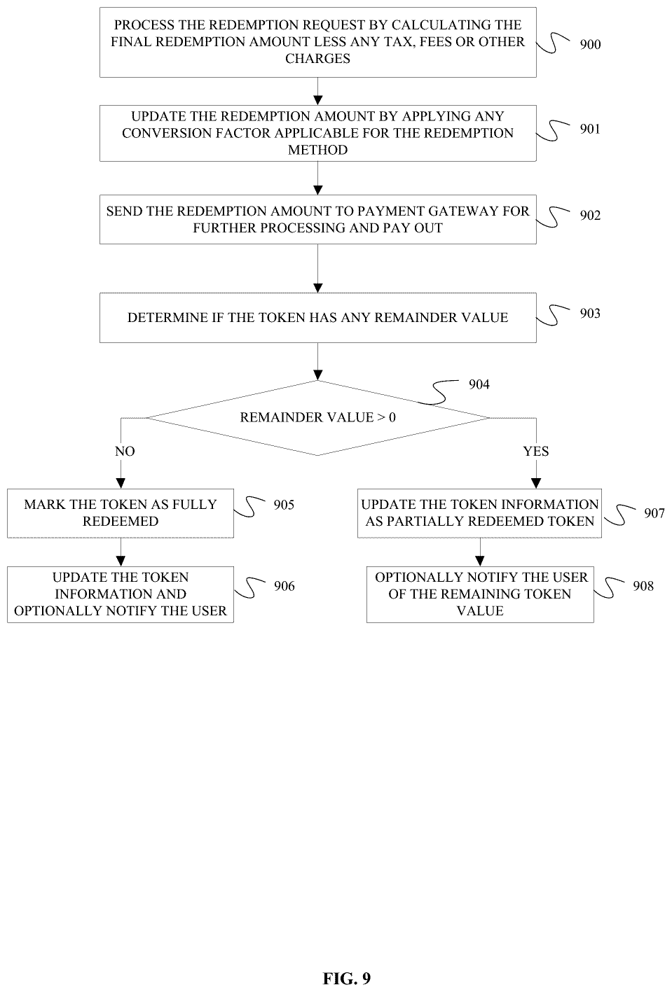

In another embodiment of the payment processing as shown in flow diagram of FIG. 9, central controller computes the final redemption amount less any tax or fees charges in step 900. Central controller, in step 901, may convert the redemption amount from the default currency to a payment amount in another currency or to an amount in a gift card balance or to an amount in store credit et cetera based on the redemption method specified in the redemption request. The actual conversion value is calculated by the central controller 101 using the information received from payment processors and payment gateway entities. In step 902, central controller sends the message comprising the payment instructions to a payment gateway entity for further processing. In step 904 by central controller computes the remainder value of the token after subtracting the requested redemption amount from the current value of the token. In step 907, central controller updates the weights for each selected asset so that the weighted average of current asset value is equivalent to the remainder amount value of the token less any transaction costs or fees. Token information is updated in the tokens database 205 in step 907 and a notification to the user may be sent in step 908.

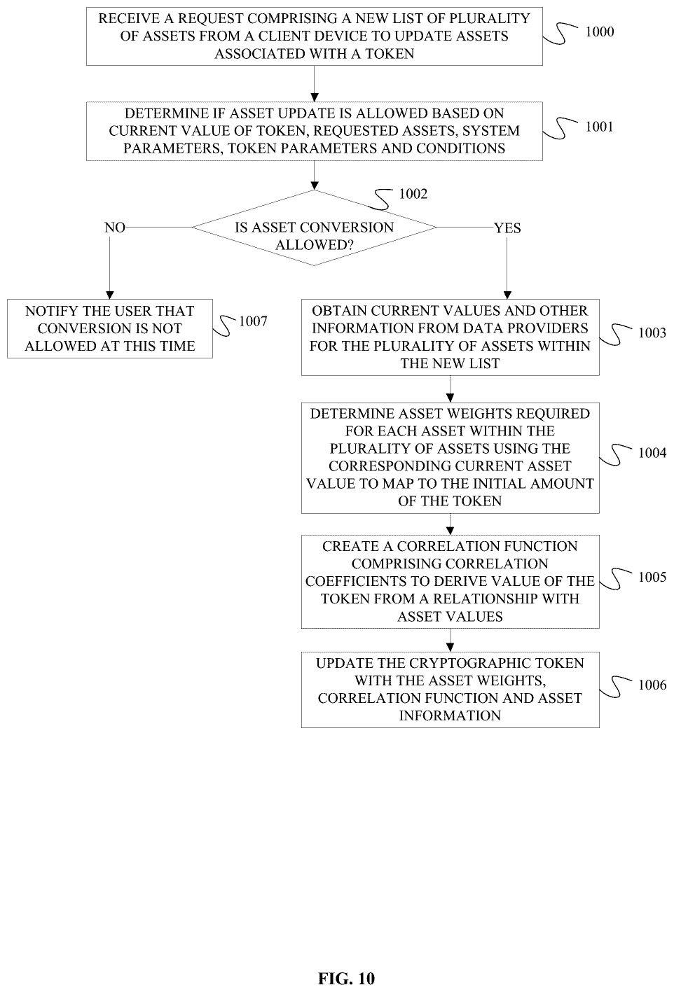

Another embodiment of the present invention allows the assets associated with a token to be changed after the first asset allocation as shown in the flow diagram of FIG. 10. In step 1000, central controller receives a request to comprising a new list of assets to be associated with an existing token. In step 1001, central controller checks the token attributes to confirm if asset change is allowed for the token. If asset change is not allowed then central controller notifies the requester in step 1007. If asset change is allowed then central controller obtains the current prices or value of assets in the new list in step 1003. In step 1004, central controller determines the weights for each selected asset in the new asset list so that the weighted average of current asset value is equivalent to the current amount value of the token less any transaction costs or fees. Central controller also creates a new correlation function to track the value of new assets using the token in step 1005. Token information is updated in the tokens database 205 and a notification to the user may be sent in step 1006.

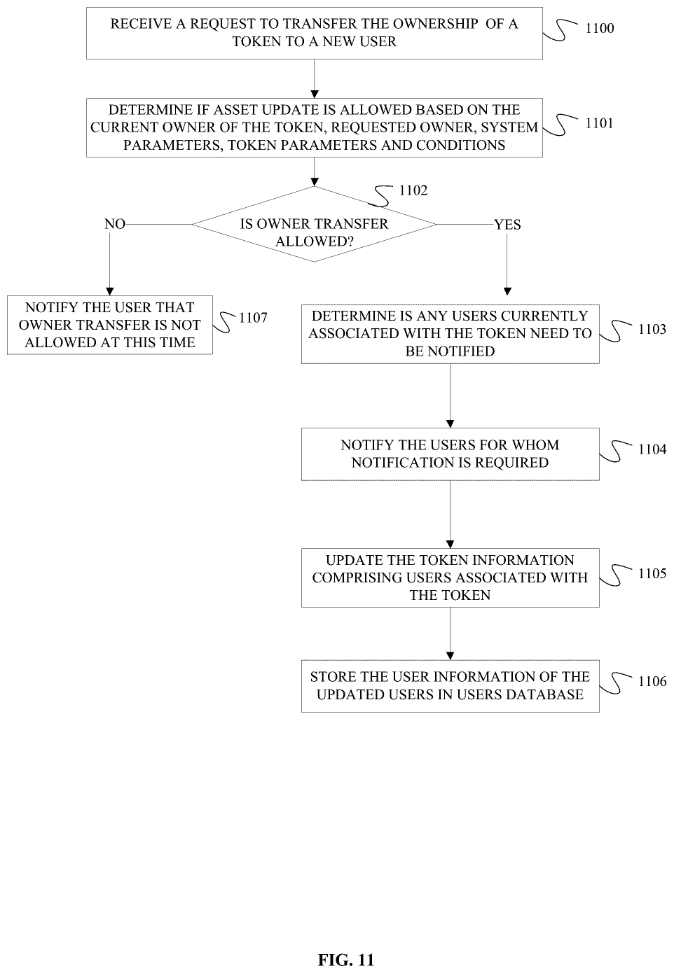

In some embodiments, the system and method may also be practiced to allow the transfer of ownership of the token from the first user to a second user. FIG. 11 shows the flow diagram for processing the ownership changes of the tracking cryptographic token. In step 1100, central controller receives a request to transfer the ownership of the token to a new user. In step 1101, central controller checks the token attributes to confirm if ownership change is allowed for the token. If ownership change is not allowed then central controller notifies the requester in step 1107. If ownership change is allowed then, in step 1103 central controller check if any existing users associated with the token need to be notified about the ownership change. Central controller sends notification in step 1104 to the client devices associated with the users who need notification for ownership change. In step 1105, central controller updates the token information in tokens database. Central controller also adds the user information of the new user in user accounts database 206 in step 1106.

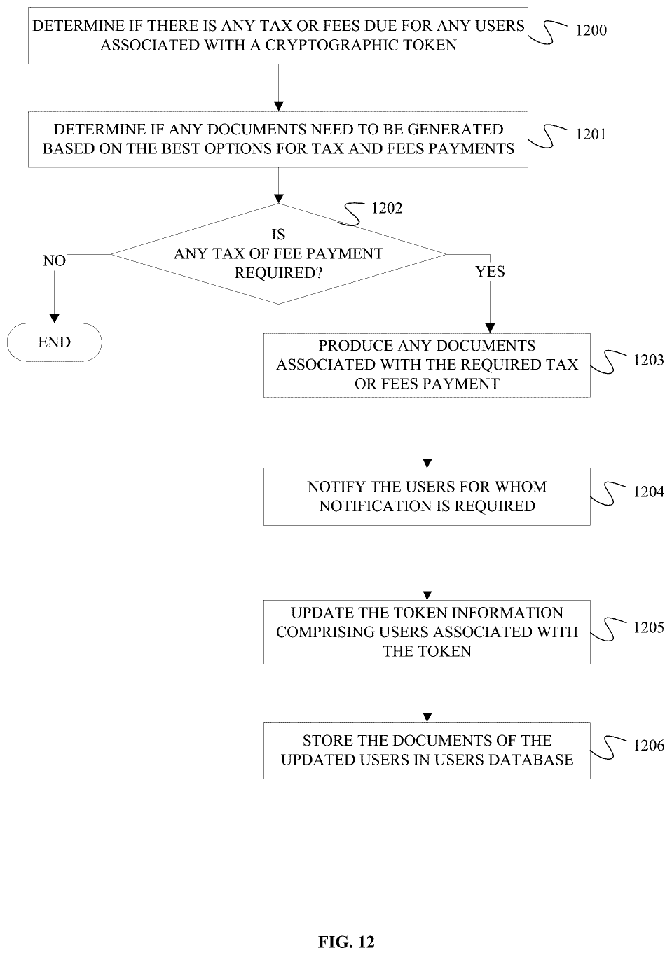

One embodiment of this invention allows central controller 101 to determine the tax or fees associated with the token value changes, for example, income tax calculation if value of the token has increased significantly due to the changes in the value of the underlying assets that the token is tracking. FIG. 12 shows a flow diagram where in step 1200 central controller determines the tax or fees due to the change in token value. Central controller then determines which documents may need to be generated to fulfil the tax or fees obligations in step 1201. For example, any change in value above $700 may require a 1099 form to be produced in USA. In step 1203, central controller produces the required document. Such document may either be produced locally at the central controller or through a remote procedure call (RPC) by the central controller. Central controller notifies the user in step 1204, and updates the token information for tax or fees due in step 1205. Central controller may also store the document in the user account database as depicted in step 1206.

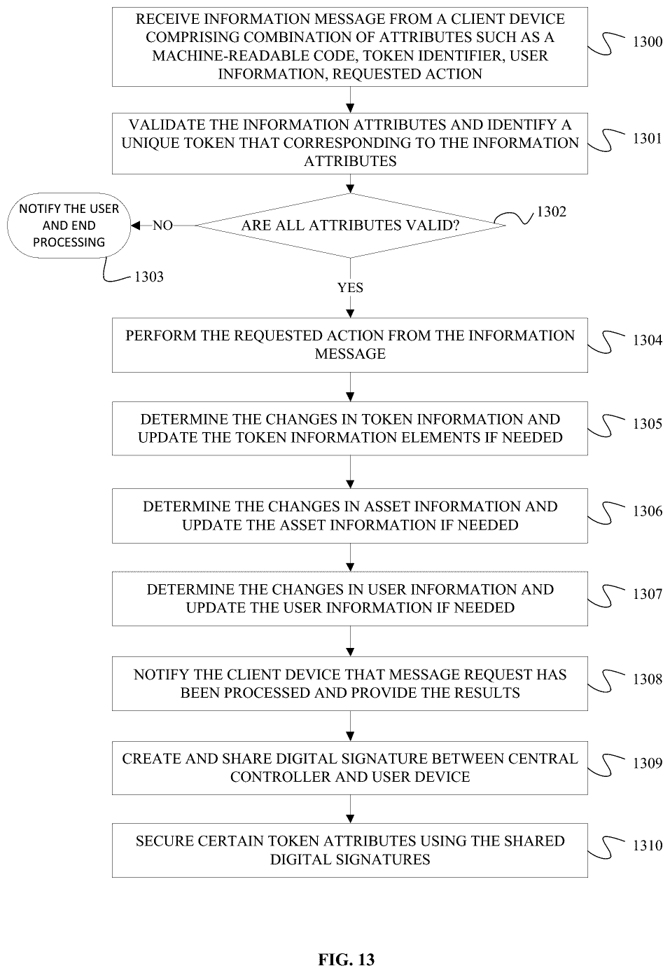

In another embodiment, a user associated with the token may request changes in token attributes. In this regard, FIG. 13 shows a flow diagram of processing such requests. In step 1300, central controller receives a request from a client device wherein the request comprises machine-readable code or token identifier associated with the token and the request action to be performed on the token. In step 1301, central controller checks the validity of the token, ownership information et cetera. If request is not valid then central controller rejects the request and sends a notification to the requesting client device in step 1303. If request is valid then central controller performs the requested action in step 1304. An example of such requested action may include locking the token from redemption. Still another example of such request may include making two users as owners of the token with each user having a 50% ownership et cetera. Central controller then updates the token information attributes and updates the tokens database in step 1305, updates the asset information changes in step 1306, updates the user information changes in step 1307. In step 1308, central controller notifies the client devices associates with users of the token. Central controller may also choose to create digital signatures such as a SSL key pair between central controller and client device as shown in step 1309. Central controller may also request client devices to sign the data attributes using their private keys for securing the information update as in step 1310.

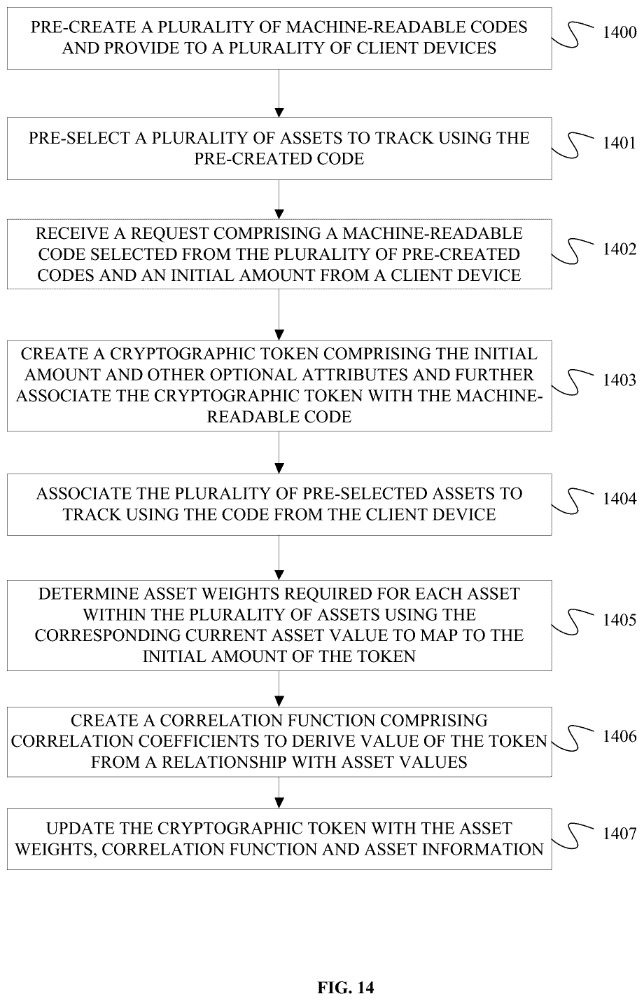

In still another embodiment of the present invention, central controller may pre-select the list of assets that can be associated with a cryptographic token. Such list may be determined by the central controller using Artificial Intelligence and Machine Learning methods as shown in FIG. 14. In step 1400, central controller pre-creates a plurality of machine-readable codes and distributes them to the plurality of client devices. In step 1401, central controller pre-selects a list of assets that are available for tracking using a token associated with a specific machine-readable code. When central controller receives a request to create a token corresponding to a pre-created machine-readable code then central controller uses the list of automatically pre-selected assets and automatically chosen weights for each asset for that token to track as shown in step 1404. Central controller then determines the asset weights in step 1405 and the correlation function for asset performance tracking in step 1406. Central controller updates the cryptographic token in step 1407 and stores it in the tokens database 205.

The central controller may also determine various actions for each asset associated with a token to track the value of asset. Such actions may include verifying the information related to the asset, obtaining the current price of the asset, determining and buying a certain quantity of the asset, determining and selling a certain quantity of the asset, hedging the quantity of asset using other assets. Central controller can then send these instructions to asset service providers 106B shown in FIG. 1 to execute the instructions. Asset service providers 106B can send the response messages to the central controller 101 providing the result for the instructions.

### Example 1

FIG. 4 shows attributes included in a cryptographic secured token used for mapping token value to a combination of plurality of assets and tracking the temporal changes in the value of plurality of assets according to a correlation function of the token. A central controller 101 comprising a processor 208 and data processing application 202 executed by the processor shown in FIG. 2 computes weights for each asset in the plurality of assets such that the current value of token is equal to the weighted average of the value of the plurality of assets. For example, a token with an initial monetary value of $40 dollars may be associated with 0.1 share of S&P500 ETF at a current value of $400 dollars further tracking the change in the price of S&P500 ETF at 80% for positive change and 100% for negative change.

The initial quantity of assets associated with the token is determined so that the initial value of the token has a functional relationship with the value of associated assets at the time of token creation. If token is created at time to then:

V_{c}|t=0=f(Aₖ|t=0)
Where
V_{c}|t=0 represents the value of cryptographic token C at time t=0;
Aₖ|t=0 represents the value of an asset k∈[1, n];
n represents the number of assets associated with the cryptographic token C.

If current value of an asset k in the plurality of assets is represented as Ak and the weight of corresponding asset is represented as wk in the data then the current value V of the cryptographic token C is:

$${V}_{C} = \frac{{\sum }_{k = 1}^{k = n} {w}_{k} * {A}_{k}}{{\sum }_{k = 1}^{k = n} {w}_{k}}$$

Where n represents the total number of assets in the set of assets representing the plurality of assets associated with a given token T. Asset k may be represented by a unique identifier in the assets repository 207 along with other information elements corresponding to the asset.

In one embodiment, the central controller may send the weight and asset pairs to client device 108 for displaying it to the user 107. The client device can send an approval to the central controller by signing the weight and asset pairs using private key associated with the user along with user specific elements such as a personal identification number (PIN), fingerprint of the user from the device fingerprint scanner or face ID of the user using device camera. The weights and asset identifiers are stored in the token information elements.

Central controller also generates a tracking function to create a relationship between the token value and the value of the underlying assets associated with the token. The tracking function is a type of correlation function to establish a deterministic and exact relationship between the value of the token at any time t and the values of the corresponding underlying assets associated with the token.

In general, the present invention established a functional relationship for calculating the monetary value of the cryptographic token C at a given time t based on the value of each asset Aₖ at the given time t in the plurality of n assets associated with the token so that: V_{C,t}=f(A_{k,t}) for each k∈[1, n] where f represents a mathematical function.

In one embodiment of the present invention, the tracking function may include conditional value such as:

$${V}_{C , t} = \{ \begin{matrix}{f}_{1} ( {Δ}_{{A}_{k}} ) for each k ∈ [ 1 , n ] for {Δ}_{{A}_{k}} \geq 0 \\ {f}_{2} ( {Δ}_{{A}_{k}} ) for each k ∈ [ 1 , n ] for {Δ}_{{A}_{k}} < 0\end{matrix}$$

where Δ_{Δ}_{ₖ} is the change in value of asset Aₖ since time t=0, time when token was created and the current time t=t_{curr}. That is Δ_{Δ}_{ₖ}=A_{k,t|t=0}−A_{k,t|t=t}_{_{curr}}
f₁ represents one mathematical function and f₂ represents another mathematical function

In the preferred embodiment of the present invention the relationship may be represented by a linear function such as:

$${V}_{C , t} = {\sum }_{k = 1}^{k = n} {β}_{k} {w}_{k} {A}_{k , t} + α$$

Where V_{C,t} represents the value of the cryptographic token at time t; a represents a constant value adjustment factor; βₖ represents the correlation coefficient for the asset k; wₖ represents the weight of the asset k in the overall initial value of the token; and A_{k,t} represents the value of asset k at time t where k denotes a particular asset in the plurality of assets associated with the token T. This is just one example of a simple linear relation function. A more complex function can be used by the central controller as long as the function establishes a deterministic and exact relationship between the value of the token at any time t and the values of the corresponding underlying assets associated with the cryptographic token.

When central controller 101 receives a request to redeem the token from a client device 108, the central controller determines the current value of the token V_{C,t} using the function for deriving value of the token from the value of the underlying associated assets. If the redemption amount is less than or equal to V_{C,t} then central controller sends the request comprising the redemption amount and payment instructions to the payment processor 102 for making the payment. The payment processor 102 can process the request by making a payment using Automated Clearing House (ACH), a cheque, a debit card, a gift card, cash delivery or any other such mechanism for example. The exact method to make the payment is determined based on the redemption request received from the client device 108 and the payment instructions created by the central controller 101.

In one embodiment, the central controller may send the correlation coefficients, constant factor and asset information to client device 108 for displaying it to the user 107. The client device can send an approval to the central controller by signing the weight and asset pairs using private key associated with the user along with user specific elements such as fingerprint of the user from the device fingerprint scanner or face ID of the user using device camera. The correlation factors, constant factor and asset identifiers are stored in the token information elements.

In preferred embodiment of the present invention, a token may be associated with one or more users as the owners of the token. When one or more owner users of the token send the request to redeem the token then central controller determines the current token value available to each owner for redemption. The token value may be distributed among users using ownership distribution factors. For example:

$${\sum }_{j = 1}^{j = m} {U}_{j} = 1$$

Where Uⱼ represents the distribution factor for the user j such that if there are total m users associated with a token as owners then j∈[1, m]. And the token value available to the user j can be calculated as Vᵤ=Uⱼ*V_{c} where V_{u,j} is the token value available to user j from the total token value V_{c}.

An Example of Hashing and Encrypting Token Information

In one embodiment of the present invention central controller select a hashing algorithm such as Message-Digest algorithm (MD5), Secure Hash Algorithm (SHA-256) or other such hashing algorithm. For example, to user Secure Hash Algorithm (SHA-256), central controller applies the following processing to token data: central controller adds some extra bits to the token data so that the length of token data is exactly 64 bits less than the nearest multiple of 512 to generate padded token data. Central controller computes a 64 bit modulo of original token data and appends it to the padded token data. Token data is divided into blocks of 512 bits of data and each block goes through 64 rounds of compression function. The SHA-256 algorithm outputs a 256 bits of data block that is added to the beginning of token data.

Central controller 101 and client device 108 derive a secret key in collaboration with each other to encrypt the token. For example, central controller and client device may use Diffie-Hellman exchange to establish a secret key. Then central controller uses the key to encrypt an element of token data. Either a specific element or all elements of the token data can be encrypted. Central controller and client device may also use asymmetric encryption to securely exchange symmetric key that is used by the central controller to encrypt an element of token data elements. Central controller may store the symmetric key shared with a particular client device in the user accounts database 206 and identifiers repository 214.

Central controller may use Public Key Infrastructure (PKI) to sign the hash value of token data using private key associated with the central controller. Token can be verified by the cryptography unit 303 that is part of the client processing application 302 of a client device 108 by decrypting the hash value using the public key of the central controller corresponding to the private key. Client processing application can compare the decrypted hash value with the original hash value of the token also included in the token data to determine if token is valid.

Token can be verified by the cryptography unit 203 that is part of the data processing application 202 of the central controller 101 by decrypting the hash value using the public key of the central controller corresponding to the private key. Data processing application can compare the decrypted hash value with the original hash value of the token also included in the token data to determine if token is valid and token data has not been tempered with.

Central controller 101 computes new hash value of the token using cryptography unit 203 every time there is change in any information element of the token as indicated by the token processing unit 204. After computing the hash value, central controller again encrypts the hash value using a private key associated with the central controller. Central controller 101 also sends information about its public key to all the client devices 108 using a secure communication channel such as Secure Hypertext Transfer Protocols (HTTPS).

While certain embodiments of the inventions have been described, these embodiments have been presented by the way of example only, and are not intended to limit the scope of the disclosure. Indeed, the novel methods and system described herein may be embodied in a variety of other forms; furthermore, various omissions, substitutions and changes in the form of the methods and systems herein may be made without departing from the spirit of the disclosure. The accompanying claims and their equivalents are intended to cover such forms or modifications as would fall within the scope and spirit of the inventions.

The skilled person will be aware of a range of possible modifications of the various embodiments described above. Accordingly, the present invention is defined by the claims and their equivalents.

What is claimed is:

1. A method for creating a digital token having a monetary value and determining the monetary value of the digital token from monetary value of a plurality of assets associated with the digital token using a data processing application comprising:
receiving a request from a client device associated with a user to create the digital token wherein the request comprises an initial monetary amount and a plurality of identifiers wherein first identifier is associated with a first asset in the plurality of assets;
determining an initial monetary value of the digital token based on the initial monetary amount from the request;
identifying a spot monetary value of each asset in the plurality of assets;
creating a correlation function to assign a plurality of weighting factors wherein a first weighting factor is associated with first asset in the plurality of assets based on the initial monetary value of the digital token and the spot monetary value of the first asset;
creating a token identifier for the digital token;
encrypting the digital token using a secret key;
updating the monetary value of the digital token at a given time using the correlation function with the plurality of the weighting factors and the spot monetary values of the plurality of assets;
implementing a plurality of transactions related to a plurality of digital tokens; and distributing the monetary value paid during the plurality of transactions for the plurality of digital tokens using the updated monetary value of the digital token in the plurality of digital tokens.

2. The method of claim 1, further comprising associating the token identifier with a machine-readable code.

3. The method of claim 1, wherein the token identifier is stored in a blockchain.

4. The method of claim 1, further comprising: automatically determining the first weighting factor of the first asset in the plurality of assets and actions related to the first asset based on a type of transaction related to the digital token.

5. The method of claim 1, wherein the request from the client device further comprises a plurality of user identifiers designated as owners of the digital token and an ownership factor of the digital token for first user identifier in the plurality of user identifiers; and the method comprising associating the digital token with the plurality of user identifiers and storing the ownership factor for the first user identifier.

6. The method of claim 1, wherein the request from the client device further comprises a transaction request to convert the digital token into a second token for a partial amount of the updated monetary value of the digital token.

7. The method of claim 1, further comprising, receiving information for the first asset in the plurality of assets wherein the information includes at least the monetary value of the first asset, a unit value of the first asset, a currency type for the monetary value, a timestamp for the spot monetary value, an identifier for the client device providing the monetary value, and an asset identifier for the first asset at the client device.

8. The method of claim 1, further receiving a second request comprising an identifier for the digital token and a second plurality of assets to be associated with the digital token.

9. The method of claim 8, further comprising determining current value of the digital token and updating the correlation function to assign a second plurality of weighting factors wherein a weighting factor is associated with each asset in the second plurality of assets based on the initial monetary value of the digital token and the spot monetary value of the first asset.

10. The method of claim 1, where the request comprises a holding period for the digital token wherein the holding period determines a minimum time period before the digital token can be converted into a second token or redeemed in a monetary transaction.

11. A system comprising a central controller wherein the central controller further comprises:
a memory for storing a programmable code;
a database for storing data;
a processor for executing the programmable code, wherein the programmable code comprises a data processing application executed to:
receive a request from a client device associated with a user to create a digital token wherein the request comprises an initial monetary amount and a plurality of identifiers wherein first identifier is associated with first asset in a plurality of assets;
determine an initial monetary value of the digital token based on the initial monetary amount from the request;
determine a spot monetary value of each asset in the plurality of assets;
create a correlation function to assign a plurality of weighting factors wherein a first weighting factor is associated with a first asset in the plurality of assets based on the initial monetary value of the digital token and the spot monetary value of the first asset;
create a token identifier to uniquely identify the digital token and store the token identifier in the database;
encrypt the digital token using a secret key;
compute present monetary value of the digital token at a given time by executing the correlation function with the plurality of the weighting factors and the spot monetary values of the plurality of assets;
implement a plurality of transactions related to a plurality of digital tokens; and distribute a monetary value paid during the plurality of transactions for the plurality of digital tokens using the present monetary value of the digital token in the plurality of digital tokens.

12. The system of claim 11 wherein the data processing application associates the token identifier with a machine-readable code.

13. The system of claim 11, wherein the token identifier is stored in a blockchain.

14. The system of claim 11, wherein the data processing application automatically determines a weighting factor of the first asset in the plurality of assets and actions related to the first asset based on a type of transaction related to the digital token.

15. The system of claim 11, wherein the request from the client device further comprises a plurality of user identifiers designated as owners of the digital token and ownership factor of the digital token for first user identifier in the plurality of user identifiers; and the data processing application associates the digital token with the plurality of user identifiers and store the ownership factor for the first user identifier in the database.

16. The system of claim 11, wherein the request from the client device further comprises a transaction request to convert the digital token into a second token for a partial amount of the present monetary value of the digital token.

17. The system of claim 11, wherein the data processing application receives information for the first asset in the plurality of assets; the information further comprising at least the monetary value of the first asset, a unit value of the first asset, a currency type for the monetary value, a timestamp for the spot monetary value, an identifier for the client device providing the monetary value, and an asset identifier for the first asset at the client device; and the system further storing the information in the database.

18. The system of claim 11, further receiving a second request comprising an identifier for the digital token and a second plurality of assets to be associated with the digital token.

19. The system of claim 18, wherein the data processing application determines current value of the digital token and updates the correlation function to assign a second plurality of weighting factors wherein a weighting factor is associated with each asset in the second plurality of assets based on the initial monetary value of the digital token and the spot monetary value of the first asset.

20. The system of claim 11, wherein the request comprises a holding period for the digital token wherein the holding period determines a minimum time period before the digital token can be converted into a second token or redeemed in a monetary transaction.
